(19) United States
(12) Patent Application Publication
(10) Pub. No.: US 2015/0169858 A1
(43) Pub. Date: Jun. 18, 2015

(54) PLUGGABLE AUTHENTICATION MECHANISM FOR MOBILE DEVICE APPLICATIONS

(71) Applicant: Alcatel Lucent, BOULOGNE BILLANCOURT (FR)

(72) Inventor: Priya Tg, Bangalore (IN)

(21) Appl. No.: 14/413,934

(22) PCT Filed: Jul. 11, 2013
(86) PCT No.: PCT/EP2013/064710

§ 371 Date: Jan. 9, 2015

(30) Foreign Application Priority Data
Aug. 29, 2012 (IN) 2681/DEL/2012

(51) Int. Cl. G06F 21/32

(52) U.S. Cl. CPC G06F 21/32

(57) ABSTRACT

A method and system for authenticating a user to provide access to a secure application configured on a mobile device are disclosed. The method includes receiving an input from the user. The input is associated with a plurality of parameters. The method includes extracting a biometric pattern based on the input. The biometric pattern may be generated from the plurality of parameters associated with the input. The method may include comparing the biometric pattern with a plurality of reference patterns. The plurality of reference patterns are pre-defined by an owner of the mobile device. Furthermore, the method may include authenticating the user when the biometric pattern matches a reference pattern associated with the secure application from the plurality of reference patterns. Moreover, the method includes allowing the user to access the secure application, based on the authentication.

### FIELD OF INVENTION

The present subject matter relates to authentication mechanism for mobile device applications, and, particularly, but not exclusively, to a pluggable authentication mechanism for mobile device applications.

### BACKGROUND

Communication devices, such as mobile devices, are gaining popularity as more users are relying on these devices, particularly smart phones, as a primary source for accessing the Internet. The mobile devices have changed significantly, in terms of both form factor and underlying capabilities, over a period of time. Moreover, introduction of third generation (3G) technologies have made the underlying capabilities of the mobile devices available for a wide variety of innovative data-oriented services. The capabilities make the mobile devices versatile, for example, the mobile devices may be used as a contactless wallet, a barcode reader, a satellite navigation system, an email or social network client, a Wi-Fi hotspot, and may be used to make a phone call.

Often, the mobile devices contain personal information, such as credit card data, bank account numbers, passwords, and contact data. In other words, the users may treat the mobile devices as a primary repository of personal information. Further, the users access various online applications through the mobile devices and therefore, personalize the mobile devices in terms of data stored therein and types of services provided by the mobile devices. Accordingly, the mobile devices are required to include rigorous and convenient data protection techniques, such as user authentication techniques, in case the mobile devices are lost or stolen.

Typically, user authentication in the smart phones is dominated by password based approaches, which interfere with user experience since many users find it cumbersome to remember and input passwords frequently in their mobile devices. Further, most mobile devices support security mechanisms that offer an all-or-nothing access to the users. As a result, it allows easy access of the personal information of the mobile device user to others even if the user shares their mobile device with others for a limited purpose only. This may cause security and data privacy concerns among the mobile device users and adversely affect willingness of the users to share the mobile devices. Additional levels of user authentication on the mobile devices also fall short, both in providing user authentication while accessing the personal information as well as in providing desirable levels of user experience.

### SUMMARY

This summary is provided to introduce concepts related to a pluggable authentication mechanism for mobile device applications. This summary is not intended to identify essential features of the claimed subject matter nor is it directed to use in determining or limiting the scope of the claimed subject matter.

In an aspect, a method for authenticating a user for providing access to a secure application configured on a mobile device is disclosed. The method may include receiving an input from the user for accessing the secure application. The input may be associated with a plurality of parameters. The method may further include extracting a biometric pattern from the input received from the user. The biometric pattern may be generated from the plurality of parameters associated with the input. In addition, the method may include comparing the biometric pattern with a plurality of reference patterns. The plurality of reference patterns may be pre-defined by an owner of the mobile device. Furthermore, the method may include authenticating the user when the biometric pattern matches a reference pattern associated with the secure application. Moreover, the method may include allowing the user to access the secure application of the mobile device.

In another aspect, the present subject matter discloses a mobile device for authenticating a user to access a secure application configured thereon. The mobile device may include a processor, a detection module coupled to the processor, and a security module coupled to the processor. The detection module may be configured to receive an input from a user for accessing the secure application. The input may be associated with a plurality of parameters. The detection module may further be configured to determine a biometric pattern generated based on the input received from the user. Further, the security module may be configured to extract a plurality of reference patterns from a repository. The plurality of reference patterns may be pre-defined by an owner of the mobile device. The security module may further be configured to compare the biometric pattern with the plurality of reference patterns. The security module may authenticate the user when the biometric pattern matches a reference pattern from the plurality of reference patterns associated with the secure application. In addition, the security module may be configured to allow the user to access the secure application.

In yet another aspect, a computer readable medium having embodied thereon a computer program for executing a method for authenticating a user to provide access to a secure application configured on a mobile device is disclosed. The method may include receiving an input from the user for accessing the secure application. The input may be associated with a plurality of parameters. The method may further include extracting a biometric pattern from the input received from the user. The biometric pattern may be generated from the plurality of parameters associated with the input. In addition, the method may include comparing the biometric pattern with a plurality of reference patterns. The plurality of reference patterns may be pre-defined by an owner of the mobile device. Furthermore, the method may include authenticating the user when the biometric pattern matches a reference pattern associated with the secure application. Moreover, the method may include allowing the user to access the secure application of the mobile device.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a mobile device, in accordance with an embodiment of the present subject matter.

FIG. 2 illustrates an exemplary method for authenticating a user to provide access to a secure application of the mobile device, in accordance with an embodiment of the present subject matter.

FIG. 3 illustrates an exemplary method for authenticating a user to provide access to a timed-out secure application configured on the mobile device, in accordance with another embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

Systems and methods providing a pluggable authentication mechanism using biometrics for mobile device applications are described. The mobile devices that can implement the described method(s) include, but are not limited to, mobile phones, hand-held devices, personal digital assistants (PDAs), notebooks, tablets, and the like. Although the description herein is explained with reference to a mobile device, such as a smart phone, the described method(s) may also be implemented in any other devices that may be configured with a touch screen, as will be understood by those skilled in the art.

Additionally, the system and method can be implemented in any of the wireless communication networks, such as Global System for Mobile Communication (GSM) network, Universal Mobile Telecommunications System (UMTS) network, cdma2000 High rate packet data (HRPD) protocol networks, CDMA2000 1x, Long Term Evolution (LTE) networks, general packet radio service (GPRS) networks, and Wideband Code Division Multiple Access (W-CDMA) network. Although the description herein is with reference to certain networks, the systems and methods may be implemented in other networks and devices, albeit with a few variations, as will be understood by a person skilled in the art.

Mobile devices are used for a number of applications, such as looking up some information on the Internet, taking a glimpse at recent photos, playing games, reading latest updates on a social network, and the like. The mobile devices are also increasingly shared among different people, such as family members, friends, and guests. With each passing day, the mobile devices become more and more like general purpose computers. Mobile device users, at times, access and/or save personal information, such as e-mails, short message service (SMS), and photos, in the mobile device that may require protection from being accessed by unauthorized persons.

Presently, techniques for protecting data in mobile devices include password or pattern based locking mechanisms for the mobile devices. The pattern based locking may refer to a set of gestures that a user may perform to unlock a mobile device. For example, the user may be required to create a unique pattern with help of 9 points to unlock the mobile device. These current mechanisms usually unlock the entire mobile device and pose an overhead as the users need to enter the password or the pattern every time for unlocking the mobile device. Further, the password as well as the pattern may be easily traceable. Also, as the mobile devices provide more personal interaction, the password/pattern matching based authentication mechanism may not be considered user friendly as the users of the mobile device may not enjoy complete informal user experience. Thus, typing passwords on the mobile devices may become a tedious and error-prone process. Also, once the mobile device is unlocked, all applications as well as data in the mobile device may be accessible to all users and may not be restricted only to an authenticated user.

Certain biometric mechanisms may also be used to authenticate the user based on behavioral characteristics. Biometric mechanisms may be based on characteristics, such as finger pressure and voice of users, to dynamically authenticate the users while unlocking the mobile device. Typically, the biometric mechanisms also follow an all-or-nothing approach by protecting entire contents of the mobile device. Therefore, while biometric mechanism may be a more efficient way of protecting access to the personal information as compared to password protection approach, similar to the password protection approach it also leads to a reduction in user experience, since the user needs to be authenticated every time to access any application.

Conventionally, to overcome the all-or-nothing approach, multiple authentication mechanisms and time-out periods may be employed for authenticating different applications of the mobile device. The multiple authentication mechanisms may include usage of different mechanisms, such as biometrics, password mechanism, and network authentication, for different applications. Further, assigning different time-out periods for re-authenticating multiple applications on mobile devices is known. While the use of multiple authentication mechanisms and multiple time-out periods may provide security to different applications in the mobile devices, the end-user experience gets affected. Furthermore, the time-out mechanisms for re-authenticating users may impose a burden on the users to periodically provide the necessary credentials.

In various implementations of the present subject matter, methods and systems for providing pluggable authentication mechanism using biometrics for mobile device applications are disclosed. In one embodiment of the present subject matter, a security module associated with a mobile device is provided. The security module may be understood as a pluggable authentication module that may provide a common authentication mechanism for use with a wide variety of applications. The security module may be plugged to various applications of the mobile device. The owner of the mobile device may select the applications, such as secure applications for being plugged with the security module. The secure applications may refer to those applications of the mobile device which require and/or reflect personal information of an owner of the mobile device, such as e-mail and banking applications. Additionally, secure applications may refer to other applications selected, by the owner of the mobile device, for being secured by the authentication mechanism. Further, the pluggable security module may include an application programming interface (API). This API may serve as a common interface with which the secure applications are compatible. Further, the security module may be associated with a sensor for detecting any activity happening on a touch screen of the mobile device. The activities taking place on the touch screen may be referred as touch events. It will be understood that a touch event is a human touch which may be generated by a user.

The sensor may be configured to extract information about various parameters that may be associated with a touch event of the user. Examples of the different parameters may include, but are not limited to, finger pressure, duration of touch, different fingers in right/left hands, different kinds of movement (drag, click, and scroll), and scroll patterns. Furthermore, the security module may be associated with a repository that may be configured to store various reference patterns that may be defined by the owner of the mobile device. A reference pattern may be understood as a biometric pattern that may be defined by the owner with respect to various applications of the mobile device. For example, the reference pattern may be defined by the owner as a combination of type of movement of a finger, duration of hold, and pressure of the finger while generating the touch event. The security module may also be configured to compare the touch event generated by a user with the reference patterns that may be stored in the repository of the mobile device. Based on the comparison, the security module may allow or deny access to one or more applications of the mobile device.

In another embodiment of the present subject matter, the security module may facilitate configuration of a plurality of time-out values for different applications of the mobile device. For example, if no touch event is detected on the mobile device beyond a pre-configured time-out value, the security module may re-authenticate the user who may be trying to access the secure application. During re-authentication, if the touch event generated by the user does not match with the reference pattern associated with the secure application, the user may be denied access to the application.

In an implementation, the owner of the mobile device may be required to train the security module, for example, by generating various touch events using different fingers of right/left hands. The security module may store the different parameters that may be associated with the various touch events, in the repository, as the reference patterns. The owner may also protect training of the security module by means of a password. Accordingly, the present subject matter may provide an implicit authentication mechanism for authentication and replaces entering of passwords/patterns.

The present subject matter may facilitate in enhancing security in the mobile devices by selective protection of personal data through the pluggable security module that implicitly authenticates application users. The security module may be plugged to certain applications, such as secure applications that may be identified by the owner of the mobile device. This may facilitate in protecting sensitive data in the mobile device and providing an informal end user experience at the same time. Further, the applications that may not be plugged to the security module may be accessible to the owner of the mobile device as well as other users, such as friends or family members. Thus, the other users may have limited or complete access to applications and data in the mobile device when shared by the owner. Further, as the authentication is based on biometric parameters of the owner, the other users may be unable to authenticate themselves, which would have been otherwise possible in case of password or pattern based authentication.

It should be noted that the description merely illustrates the principles of the present subject matter. It will thus be appreciated that those skilled in the art will be able to devise various arrangements that, although not explicitly described herein, embody the principles of the present subject matter and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The described methodologies can be implemented in hardware, firmware, software, or a combination thereof For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof Herein, the term “system” encompasses logic implemented by software, hardware, firmware, or a combination thereof.

For a firmware and/or software implementation, the methodologies can be implemented with modules (e.g., procedures, functions, and so on) that perform the functions described herein. Any machine readable medium tangibly embodying instructions can be used in implementing the methodologies described herein. For example, software codes and programs can be stored in a memory and executed by a processing unit. Memory can be implemented within the processing unit or may be external to the processing unit. As used herein the term “memory” refers to any type of long term, short term, volatile, nonvolatile, or other storage devices and is not to be limited to any particular type of memory or number of memories, or type of media upon which memory is stored.

In another firmware and/or software implementation, the functions may be stored as one or more instructions or code on a computer-readable medium. Examples include computer-readable media encoded with a data structure and computer-readable media encoded with a computer program. Computer-readable media may take the form of an article of manufacturer. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, a system includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

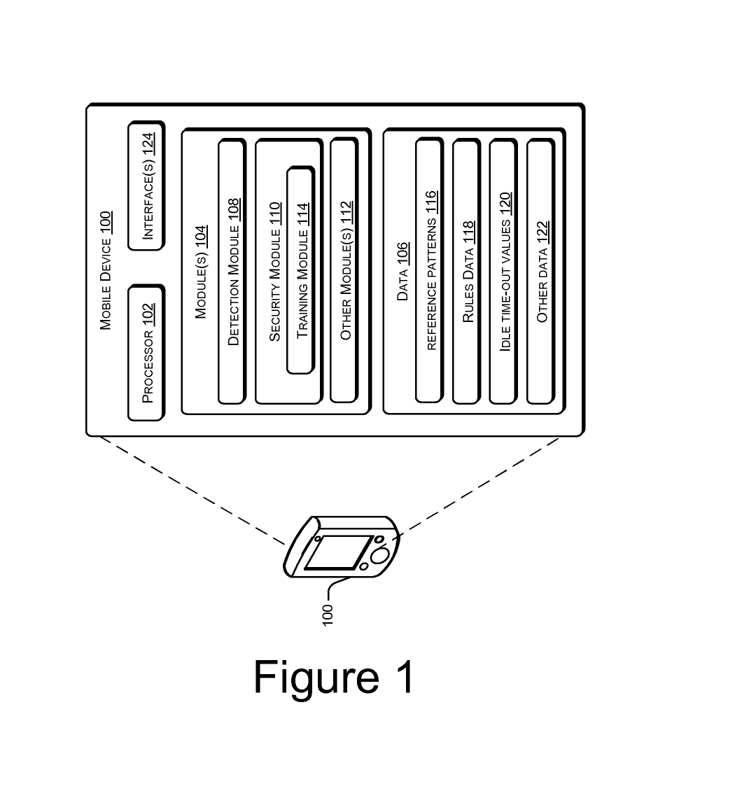

The manner in which the systems and methods for providing access to secure applications of the mobile device is implemented shall be explained in details with respect to the FIGS. 1-3. While aspects of described systems and methods providing access to secure applications of the communication system can be implemented in any number of different computing systems, transmission environments, and/or configurations, the embodiments are described in the context of the following exemplary system(s).

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” and “coupled” is used throughout for clarity of the description and can include either a direct connection or an indirect connection.

FIG. 1 illustrates the exemplary components of a mobile device 100, in accordance with an embodiment of the present subject matter. In one embodiment, the mobile device 100 is configured to authenticate a user for allowing access to various secure applications of the mobile device 100. The mobile device 100 may be implemented as various computing devices, such as a mobile phone, a smart phone, a personal digital assistant, a digital diary, a tablet, a net-book, and the like. In said embodiment, the mobile device 100 includes one or more processor(s) 102, hence forth referred to as processor 102, and a memory connected to the processor 102. The processor 102 may include microprocessors, microcomputers, microcontrollers, digital signal processors, central processing units, state machines, logic circuitries and/or any other devices that manipulate signals and data based on operational instructions. The processor 102 can be a single processing unit or a number of units, all of which could also include multiple computing units. Among other capabilities, the processor 102 is configured to fetch and execute computer-readable instructions stored in the memory.

Functions of the various elements shown in the figures, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The memory can include any computer-readable medium known in the art including, for example, volatile memory, such as RAM and/or non-volatile memory, such as flash. The mobile device 100 may include includes module(s) 104 and data 106. The module(s) 104 include routines, programs, objects, components, data structures, etc., which perform particular tasks or implement particular abstract data types. The modules 104 may also be implemented as, signal processor(s), state machine(s), logic circuitries, and/or any other device or component that manipulate signals based on operational instructions.

Further, the modules 104 can be implemented in hardware, instructions executed by a processing unit, or by a combination thereof. The processing unit can comprise a computer, a processor, such as the processor 102, a state machine, a logic array or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the modules 104 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

In one implementation, the module(s) 104 may include a detection module 108, a security module 110, and other module(s) 112. The other module(s) 112 may include programs or coded instructions that supplement applications and functions of the mobile device 100. Further, the security module 110 may include a training module 114. It will be evident that the module(s) 104 and data 106 may be a part of the memory of the mobile device 100. On the other hand, the data 106, amongst other things, serves as a repository for storing data processed, received, associated, and generated by one or more of the module(s) 104. The data 106 includes, for example, reference patterns 116, rules data 118, and idle time-out values 120. The data 106 may also include other data 122. The other data 122 includes data generated as a result of the execution of one or more modules in the other module(s) 112. The data 106 is shown as internal to the mobile device 100; however, it will be evident to a person skilled in the art that the data 106 may be external to the mobile device 100.

Further, the mobile device 100 includes one or more interface(s) 124. The interfaces 124 may include a variety of software and hardware interfaces, for example, interfaces for peripheral device(s), such as data input output devices, referred to as I/O devices, storage devices, network devices, etc. The I/O device(s) may include Universal Serial Bus (USB) ports, Ethernet ports, host bus adaptors, etc., and their corresponding device drivers. The interface(s) 124 may facilitate the communication of the mobile device 100 with various communication and computing devices and various networks, such as Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), IP-based network, Public Switched Telephone Network (PSTN), Integrated Services Digital Network (ISDN), networks that use a variety of protocols, for example, Hypertext Transfer Protocol (HTTP), Transmission Control Protocol/Internet Protocol (TCP/IP), Wireless Application Protocol (WAP). In the present subject matter, the interface 124 of the mobile device 100 is a touch screen interface.

As mentioned previously, the mobile device 100 may include a security mechanism for authenticating a user thereof. The security mechanism may be configured to implicitly authenticate a user based on the various parameters that may be associated with touch events created by the user on a screen, such as a touch screen, of the mobile device 100.

In an implementation, the detection module 108 of the mobile device 100 may be configured to detect an input on a screen of the mobile device 100. The screen of the mobile device 100 may be referred to as a touch screen and the input may be referred as a touch event. It will be evident to a person skilled in the art that the touch screen may be configured to have both display and input functionalities. For example, the touch screen may display text and images at the same time the touch screen may sense input from a finger or a stylus. In various implementations of the present subject matter, the touch event may be understood as a human touch that may impact surface of the touch screen of the mobile device 100. It will be understood that the touch event will be generated by the user of the mobile device 100.

The detection module 108 may therefore, detect the input through one or more sensors (not shown), such as a touch sensor and a pressure sensor that may be coupled to the screen of the mobile device 100. The touch sensor may be configured to detect any activity happening on the screen of the mobile device 100. Examples of the touch sensor may include, but are not limited to, a capacitive sensor and a resistive sensor. It will be evident that the screen of the mobile device 100 may also be referred as an interface, such as the interface 124.

Further, the touch event may be associated with a plurality of parameters. The plurality of parameters may be biometric parameters that are unique for every person. Examples of the plurality of parameters may include, but are not limited to, finger pressure, duration of touch, fingers in right/left hands, movement of the fingers, and scroll patterns. Furthermore, the one or more sensors may be configured to extract information about the plurality of parameters associated with the touch event. Based on the extracted information, the detection module 108 may determine a biometric pattern generated from the touch event. In an implementation, the biometric pattern may be formed as a combination of multiple parameters associated with the touch event. For example, a biometric pattern may be formed as a combination of finger pressure of the user, duration of touch, and type of movement. As will be explained later, the present subject matter enables an owner of the mobile device 100 to define various biometric patterns by using different combinations of the parameters associated with the touch event. It will be evident to a person skilled in the art that the owner of the mobile device 100 may or may not be same as the user of the mobile device 100. Further, the detection module 108 may be associated with the security module 110.

The security module 110 may be configured to provide security to the mobile device 100 based on the biometric patterns determined by the detection module 108. The security module 110 may be understood as a pluggable authentication module for providing common authentication mechanism that may be used with a wide variety of applications. The security module 110 may be plugged with selective applications for being protected from unauthorized usage. For example, the security module 110 may be plugged with personal mails and banking applications. Accordingly, the security module 110 may authenticate every user who may try to access the selective applications. In various implementations, the security module 110 may be integral to the mobile device 100, may be a part of hardware/software, or may be downloaded and installed on the mobile device 100. The security module 110 may facilitate in customization of the mobile device 100. The security module 110 may be associated with a repository, such as data 106. The data 106 may be configured to store reference patterns 116. A reference pattern may be understood as a biometric template that may be defined by the owner of the mobile device 100. As will be evident, the reference patterns 116 may include combination of one or more touch events. As will be described in later paragraphs of the specification, the security module 110 may be trained by the owner of the mobile device 100. Further, the security module 110 may retrieve the reference patterns 116 from the data 106. Based on the retrieved reference patterns 116, the security module 110 may compare the biometric pattern determined by the detection module 108 with the reference patterns 116.

If the biometric pattern matches any one of the reference patterns 116, the security module 110 may authenticate the user to access one or more secure applications in the mobile device 100. The present subject matter facilitates the owner to provide access rights to the authenticated users based on the level of authentication. The owner may be able to customize the access rights by means of the training module 114 that may enable the owner of the mobile device 100 to train the security module 110. For example, the training module 114 may facilitate the owner to define various biometric patterns and save them as the reference patterns 116 in the mobile device 100. The security module 110 may save various biometric parameters, such as finger pressure, duration of touch, and kind of movement (drag, scroll, tap, pinch in, pinch out, and click) associated with the reference patterns 116 as generated by the owner. Further, the training module 114 may facilitate the owner to edit the reference patterns 116. For example, other known users, such as family and friends, may be frequently accessing the mobile device 100 of the owner. Accordingly, the owner may store biometric patterns of the other known users as reference patterns.

The training module 114 may also facilitate the owner of the mobile device 100 to associate one or more reference patterns with at least one application of the mobile device 100. An application may be a self-contained user application, such as a calendar software and MP3 player, or web-browser based applications. In an exemplary scenario, the owner of the mobile device 100 may configure secure applications, such as e-mail and banking applications on the mobile device 100. The secure applications may refer to those applications of the mobile device 100 which require and/or reflect personal information of the owner, and those applications that have been selected by the owner for being secured. The owner may include additional level of security for the secure applications apart from locking the mobile device 100. The owner may use the training module 114 to impart such additional level of security. As described above, the owner may train the security module 110 to allow selective access to the secure applications. For example, the owner may train the security module 110 to allow users to access the secure applications only when the biometric pattern matches all of the reference patterns 116 as stored by the owner.

Further, the training module 114 may facilitate the owner to associate biometric patterns of different users with different applications of the mobile device 100. This may enable restricted access to applications of the mobile device 100 by different users. For example, the owner of the mobile device 100 may not allow other users to access the secure applications, such as the e-mail and banking applications. Therefore, the owner may associate such applications with reference patterns 116 that are unique to the owner. When the other users try to access the secure applications, the security module 110 upon comparing the biometric patterns of the other users with the reference patterns 116 associated with the secure applications, may not authorize the other users to access the secure applications. As mentioned above, the owner may train the security module 110 to authorize the other users to access non-secure applications, such as gaming applications, of the mobile device 100. It will be understood that the non-secure applications refer to the applications that do not provide personal information of the owner of the mobile device 100.

In an implementation, the training module 114 may enable the owner to define rules for the security module 110. These rules may be stored within the mobile device 100 as rules data 118. The rules data 118 may include details about the applications of the mobile device 100 that may be accessible to an authenticated user. The owner may set rules to allow selective access to the applications configured in the mobile device 100. In another implementation, the rules data 118 may include information about the reference patterns 116 that may be associated with each of the secure and non-secure applications of the mobile device. In one example, the owner may define three different reference patterns that may be formed as a combination of different parameters for accessing the secure applications. The owner may define a rule that to access the secure applications, the three different reference patterns need to match the biometric pattern detected by the detection module 108. Further, if the biometric pattern matches two out of the three reference patterns, the user may be given access to the non-secure applications of the mobile device 100.

In another implementation, the training module 114 may facilitate the owner of the mobile device 100 to assign idle time-out periods for the secure applications configured on the mobile device 100. The idle time-out period for an application may refer to the duration of time till when no activity is detected on the touch screen of the mobile device 100. The training module 114 may also be configured to store the idle time-out periods as idle time-out value 120. In an implementation, the owner may define different idle time-out periods for different applications of the mobile device 100. In an example, the owner may define the idle time-out period as 2 minutes for the secure applications configured on the mobile device 100 and leaves the mobile device 100 unattended with the secure applications open on it. Once the idle time-out value 120 has exceeded, i.e., no activity is detected on the screen of the mobile device 100 for 2 minutes, the security module 110 may re-authenticate users who may try to access the secure applications that were being used on the mobile device 100. In other words, as the mobile device 100 remains unattended for some time, the mobile device 100 may get locked. Further, as the secure applications were open on the mobile device 100, when it got locked, the security module 110 may re-authenticate any user who may try to access the secure applications after the idle time-out period has exceeded. Based on the re-authentication, the security module 110 may allow the user to access the secure applications.

In an implementation, the owner may protect the training module 114 with a password to ensure that no one else may access and train the security module 110. This may facilitate in protecting the reference patterns 116, rules data 118, and the idle-time out values 120 that are stored in the mobile device 100.

The present subject matter may facilitate in authenticating a user's identity based on a combination of biometric parameters. This may increase the robustness of the authentication for the secure applications of the mobile device 100. Further, the security module 110 may enhance security in the mobile devices 100 by selective protection of personal data through the pluggable security module that implicitly authenticates application users. Additionally, as the authentication is biometric based, the other users may be unable to authenticate themselves, which would have been otherwise possible in case of password or pattern based authentication.

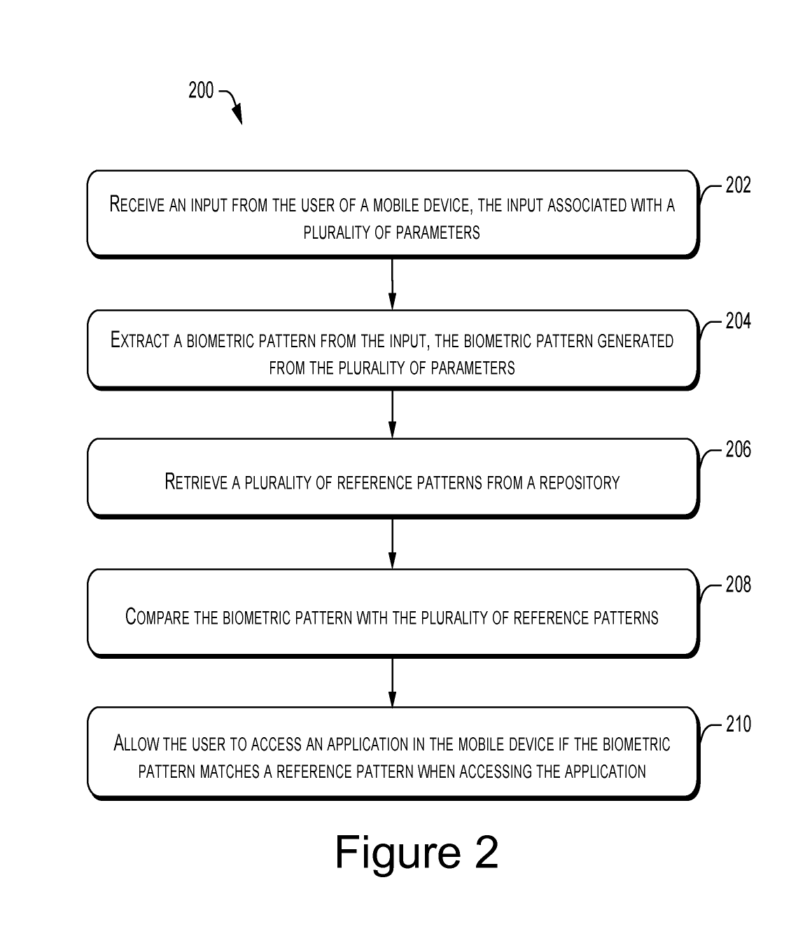

FIG. 2 illustrates a method 200 for authenticating a user to provide access to the mobile device 100, according to an embodiment of the present subject matter. The order in which the method is described is not intended to be construed as a limitation, and any number of the described method blocks can be combined in any order to implement the method 200, or any alternative methods. Additionally, individual blocks may be deleted from the methods without departing from the spirit and scope of the subject matter described herein. Furthermore, the methods can be implemented in any suitable hardware, software, firmware, or combination thereof.

The method(s) may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the methods can be performed by programmed computers. Herein, some embodiments are also intended to cover program storage devices, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices configured to perform said steps of the exemplary methods.

With reference to the method 200 depicted in FIG. 2, at block 202, an input may be received from a user of a mobile device, for example, the mobile device 100. The input may be received by the detection module 108 of the mobile device 100. The detection module 108 may be associated with one or more sensors that may facilitate in detecting any activity happening on a screen of the mobile device 100. In an implementation, the input may be a touch event that may be associated with a plurality of parameters. The plurality of parameters provides biometric information about the user. For example, the plurality of parameters may include a finger pressure, a duration of hold, type of movement of a finger, and the like.

At block 204, a biometric pattern may be extracted, for example, by the detection module 108. The biometric pattern may be extracted based on the plurality of parameters associated with the input. The biometric pattern may be analyzed by the security module 110 of the mobile device 100. The security module 110 may be understood as a pluggable authentication module for providing common authentication mechanism that may be used with a wide variety of applications. The security module 110 may be plugged with selective applications for being protected from unauthorized usage. For example, the security module 110 may be plugged with personal mails and banking applications. Accordingly, the security module 110 may authenticate every user who may try to access the selective applications.

At block 206, a plurality of reference patterns may be retrieved, for example, by the security module 110 from a repository. A reference pattern may be understood as a biometric template that may be defined by the owner of the mobile device 100. It will be understood that the repository may be internal or external to the mobile device 100. Further, the owner may train the security module 110 by means of the training module 114 to store various reference patterns for each of the applications configured in the mobile device 100. The training of the security module 110 may include storing different biometric patterns that may be generated by the owner. The security module 110 may save various biometric parameters, such as finger pressure, duration of touch, and kind of movement (drag, scroll, tap, pinch in, pinch out, and click) associated with the reference patterns 116 generated by the owner.

The security module 110 may also be trained by setting different idle time-values. This means that when an application is left unattended or idle, once the idle time-value, pre-defined by the owner of the mobile device 100, has exceeded, the security module 110 may lock the mobile device 100. Thereafter, when any user tries to access the unattended applications on the mobile device 100, the security module 110 may re-authenticate the user for allowing access to the unattended applications. Further, the owner may protect the training module 114 by means of passwords to restrict the access thereto from the other users.

At block 208, the biometric pattern determined at block 204 may be compared with the retrieved reference patterns 116. The security module 110 may be configured to compare the reference patterns 116 with the biometric pattern. Thereafter, at block 210, if the biometric pattern matches a reference pattern associated with accessing an application on the mobile device 100, the user may be allowed access of the application of the mobile device 100. It will be evident that the application will be a secure application that is plugged with the security module 110.

Accordingly, the present subject matter facilitates authentication of a user at each and every stage. Once the user is provided access of the mobile device 100, the user may, upon authentication, access various applications configured in the mobile device 100. The various applications many include, for example, secure and non-secure applications. The secure applications may be understood as the applications from which personal information of the owner may be retrieved, such as banking applications, e-mailing applications, and SMS applications. On the other hand, the non-secure applications may be understood as the applications where personal information of the owner of the mobile device 100 may not be accessed, such as camera functions, internet browsing, etc.

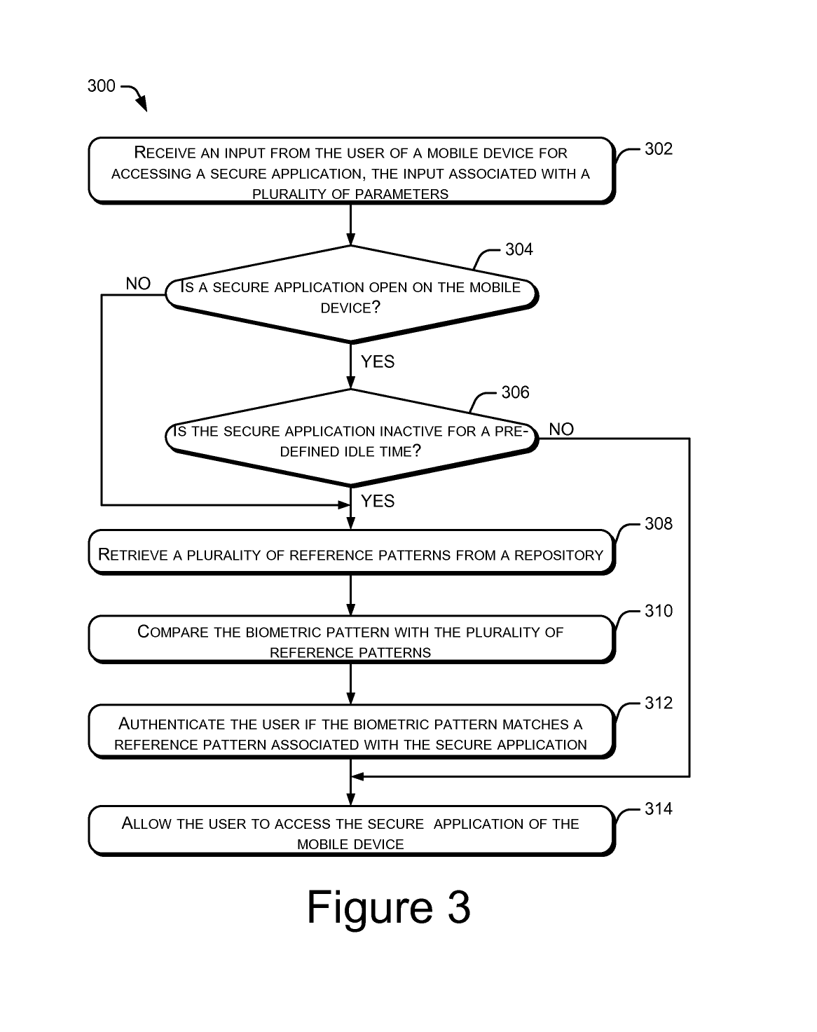

FIG. 3 illustrates an exemplary method 300 for authenticating a user to provide access to a timed-out secure application configured on the mobile device 100, in accordance with another embodiment of the present subject matter. The order in which the method is described is not intended to be construed as a limitation, and any number of the described method blocks can be combined in any order to implement the method 300, or any alternative methods. Additionally, individual blocks may be deleted from the methods without departing from the spirit and scope of the subject matter described herein. Furthermore, the methods can be implemented in any suitable hardware, software, firmware, or combination thereof.

The method(s) may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the methods can be performed by programmed computers. Herein, some embodiments are also intended to cover program storage devices, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices configured to perform said steps of the exemplary methods.

With reference to the method 300 depicted in FIG. 3, at block 302, an input for accessing a secure application may be received from a user of a mobile device, for example mobile device 100. The input may be received by the detection module 108 of the mobile device 100. The detection module 108 may be associated with one or more sensors that may facilitate in detecting any activity happening on a screen of the mobile device 100. In an implementation, the input may be a touch event that may be associated with a plurality of parameters. The plurality of parameters provides biometric information about the user. For example, the plurality of parameters may include a finger pressure, a duration of hold, type of movement of a finger, and the like.

Further, a biometric pattern may be extracted, for example, by the detection module 108. The biometric pattern may be extracted based on the plurality of parameters associated with the input. The biometric pattern may be analyzed by the security module 110 of the mobile device 100.

At block 304, it is determined whether a secure application is open on the mobile device 100. It will be evident to a person skilled in the art that the security module 110 may be trained by setting different idle time-values. This means that when an application is left unattended or idle, or an idle time-value pre-defined by the owner of the mobile device 100 has exceeded, the security module 110 may re-authenticate the users who may try to access the application of the mobile device 100. Further, the owner may protect the training module 114 by means of passwords to restrict the access thereto from the other users.

For example, an owner of the mobile device 100 may leave a secure application unattended for some time. The security module 110 may activate a timer to determine the idle time of the secure application. As mentioned earlier, the idle time of the secure application is associated with inactivity on the screen of the mobile device 100. If the inactivity on the screen prolongs beyond the idle time-out value 120 preset by the owner of the mobile device 100 by means of the training module 114, the security module 110 may ask for re-authentication of the user to allow access of the secure application that was open on the mobile device 100. As described with reference to FIG. 2, a user may unlock the mobile device 100 if the mobile device 100 has got locked due to a time-out mechanism, and may try to access the secure application, which appears as a default application since it was last accessed by the owner of the mobile device 100.

In accordance with the above description, if the secure application is open, the method 300 moves to block 306, else the method 300 moves to block 308. At block 306, it is determined whether the secure application is inactive for the pre-defined idle time-out value or not. If it is determined that the secure application is inactive for the pre-defined time, the method 300 moves to block 308, else the method 300 moves to block 314.

At block 308, a plurality of reference patterns may be retrieved, for example, by the security module 110 from a repository. A reference pattern may be understood as a biometric template that may be defined by the owner of the mobile device 100. It will be understood that the repository may be internal or external to the mobile device 100. Further, the owner may train the security module 110 by means of the training module 114 to store various reference patterns for each of the applications configured in the mobile device 100. The training of the security module 110 may include storing different biometric patterns that may be generated by the owner. The security module 110 may save various biometric parameters, such as finger pressure, duration of touch, and kind of movement (drag, scroll, tap, pinch in, pinch out, and click) associated with the reference patterns 116 generated by the owner.

At block 310, the biometric pattern determined at block 204 may be compared with the retrieved reference patterns. The security module 110 may be configured to compare the reference patterns 116 with the biometric pattern. Further, at block 312, the user may be authenticated if the biometric pattern matches a reference pattern from the plurality of reference patterns associated with the secure application. Once authenticated, at block 314, the user may be provided access to the secure application of the mobile device 100.

Although embodiments for methods and systems for pluggable authentication mechanism for mobile device applications have been described in a language specific to structural features and/or methods, it is to be understood that the invention is not necessarily limited to the specific features or methods described. Rather, the specific features and methods are disclosed as exemplary embodiments for security mechanisms for mobile devices.

1. A method for authenticating a user for providing access to a secure application configured on a mobile device, the method comprising:
receiving an input from the user for accessing the secure application, wherein the input is associated with a plurality of parameters;
extracting a biometric pattern from the input received from the user, wherein the biometric pattern is generated from the plurality of parameters associated with the input;
comparing the biometric pattern with a plurality of reference patterns, wherein the plurality of reference patterns are pre-defined by an owner of the mobile device;
authenticating the user when the biometric pattern matches a reference pattern associated with the secure application; and
allowing the user to access the secure application of the mobile device.

2. The method as recited in claim 1, wherein the receiving comprises determining an idle state of the secure application, wherein the idle state of the secure application is determined based on inactivity on a screen of the mobile device for a pre-defined time.

3. The method as recited in claim 1, wherein the extracting the biometric pattern comprises identifying the plurality of parameters associated with the input received from the user.

4. The method as recited in claim 3, wherein the plurality of parameters comprise finger pressure, duration of touch, fingers in right/left hands, movement of the fingers, and scroll patterns.

5. The method as recited in claim 1, wherein the comparing comprises retrieving the plurality of reference patterns from a repository associated with the mobile device.

6. The method as recited in claim 1 further comprises predefining the plurality of reference patterns, wherein the pre-defining comprises:
creating at least one reference pattern, wherein the at least one reference pattern includes the plurality of parameters; and
associating the at least one reference pattern with the secure application.

7. The method as recited in claim 1 further comprising assigning an idle time-out value to the secure application of the mobile device, wherein the idle time-out value defines duration of time for which the secure application is in an inactive state.

8. The method as recited in claim 1, wherein the input is a touch event.

9. The method as recited in claim 8, wherein the touch event is one of a password and a pattern.

10. A mobile device for authenticating a user for accessing a secure application configured on the mobile device, the mobile device comprising:
a processor;
a detection module coupled to the processor, the detection module configured to,
receive an input from a user for accessing the secure application, wherein the input is associated with a plurality of parameters;
determine a biometric pattern generated based on the input received from the user; and
a security module coupled to the processor, the security module configured to,
extract a plurality of reference patterns from a repository, wherein the plurality of reference patterns are pre-defined by an owner of the mobile device;
compare the biometric pattern with the plurality of reference patterns;
authenticate the user when the biometric pattern matches a reference pattern from the plurality of reference patterns, wherein the reference pattern is associated with the secure application; and
allow the user to access the secure application.

11. The mobile device as claimed recited in claim 10 further comprises a training module configured to,
generate the at least one reference pattern to be defined by the owner of the mobile device;
associate the at least one reference pattern with the secure applications; and
assign an idle time-out value for the secure applications, wherein the idle time-out value is based on inactivity of a touch screen of the mobile device.

12. The mobile device as recited in claim 10, wherein the security module is a pluggable authentication module configured to be plugged with selective applications for being protected from unauthorized usage.

13. The mobile device as recited in claim 10, wherein the secure applications comprise a banking application, short message service (SMS) application, and an e-mailing application.

14. The mobile device as recited in claim 10, wherein the non-secure applications comprise a gaming application and a music player application.

15. A computer readable medium having embodied thereon a computer program for executing a method for authenticating a user for providing access to a secure application configured on a mobile device, the method comprising:
receiving an input from the user for accessing the secure application, wherein the input is associated with a plurality of parameters;
extracting a biometric pattern from the input received from the user, wherein the biometric pattern is generated from the plurality of parameters associated with the input;
comparing the biometric pattern with a plurality of reference patterns, wherein the plurality of reference patterns are pre-defined by an owner of the mobile device;
authenticating the user when the biometric pattern matches a reference pattern associated with the secure application; and
allowing the user to access the secure application of the mobile device.
